(19) United States
(12) Patent Application Publication
(10) Pub. No.: US 2025/0365702 A1
(43) Pub. Date: Nov. 27, 2025

(54) WIRELESS COMMUNICATION METHOD OF POSITIONING MEASUREMENT AND USER EQUIPMENT

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/292,155

(22) Filed: Aug. 6, 2025

Related U.S. Application Data
(63) Continuation of application No. PCT/CN2024/076152, filed on Feb. 5, 2024.
(60) Provisional application No. 63/446,209, filed on Feb. 16, 2023.

(51) Int. Cl. H04W 64/00; H04L 5/00; H04W 24/10

(52) U.S. Cl. CPC H04W 64/006; H04L 5/0035; H04L 5/0094; H04W 24/10

(57) ABSTRACT

A wireless communication method of positioning measurement, by a user equipment (UE) includes receiving a configuration information of a plurality of downlink positioning reference signal (DL PRS) resources of a plurality of transmission points (TPs) from a base station, aggregating a first DL PRS resource and a second DL PRS resource of the DL PRS resources based on the configuration information to obtain at least one positioning measurement result, and reporting the at least one positioning measurement result to the base station.

### CROSS REFERENCE TO RELATED APPLICATION(S)

This application is a continuation of International Application No. PCT/CN2024/076152, filed Feb. 5, 2024, which claims priority to U.S. Provisional Application No. 63/446,209, filed Feb. 16, 2023, the disclosures of which are hereby incorporated by reference in their entireties.

### TECHNICAL FIELD

The present disclosure relates to the field of communication systems, and more particularly, to wireless communication methods of positioning measurement and a user equipment (UE).

### BACKGROUND

The performance of positioning and accuracy of current positioning measurement are limited by a bandwidth of PRS (positioning reference signal). In the current system, PRS can be transmitted in multiple frequency layers, but a new radio (NR) system can only support positioning measurement based on PRS in each frequency layer individually. The bandwidth of PRS in one frequency layer of positioning is limited by 100 MHz. Thus, the performance of positioning is also limited. The current NR system is unable to aggregate PRS in multiple frequency layers to formulate an equivalent larger bandwidth of PRS, which can potentially boost the accuracy of positioning measurement.

Therefore, there is a need for apparatuses and wireless communication methods of positioning measurement.

### SUMMARY

In a first aspect of the present disclosure, a wireless communication method of positioning measurement, by a user equipment (UE), includes receiving a configuration information of a plurality of downlink positioning reference signal (DL PRS) resources of a plurality of transmission points (TPs) from a base station, aggregating a first DL PRS resource and a second DL PRS resource of the DL PRS resources based on the configuration information to obtain at least one positioning measurement result, and reporting the at least one positioning measurement result to the base station.

In a second aspect of the present disclosure, a wireless communication method of positioning measurement, by a base station, includes configuring, to a user equipment (UE), a configuration information of a plurality of downlink positioning reference signal (DL PRS) resources of a plurality of transmission points (TPs), requesting the UE to aggregate a first DL PRS resource and a second DL PRS resource of the DL PRS resources based on the configuration information to obtain at least one positioning measurement result, and receiving, from the UE, the at least one positioning measurement result.

In a third aspect of the present disclosure, a UE includes a memory, a transceiver, and a processor coupled to the memory and the transceiver. The UE is configured to perform the method in the first aspect.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a flowchart illustrating an example of positioning based on downlink (DL) measurement.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of positioning measurement performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of positioning measurement performed by a base station according to an embodiment of the present disclosure.

FIG. 9 is a block diagram of an example of a computing device according to an embodiment of the present disclosure.

FIG. 10 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

Positioning technology is one of core technologies of wireless communications systems and navigation systems. 5G NR system supports positioning technology. In 3rd generation partnership project (3GPP) release 16, the following positioning solutions are specified: downlink (DL) time difference of arrival (TDOA) method, uplink (UL) TDOA method, multi-round trip time (RTT) method, DL-AoD (downlink angle of departure) method, UL angle of arrival (AoA) method, and enhanced cell identifier (E-CID) method.

In 3GPP NR, downlink positioning reference signal (PRS) is introduced to support downlink positioning measurement, and sounding reference signal (SRS) for positioning is introduced to support uplink positioning measurement. Specially, the following measurements for positioning is supported in NR release 16: DL reference signal time difference (RSTD) measured from DL PRS, UL relative time of Arrival (RTOA) measured from SRS for positioning, UE receive-transmit (Rx-Tx) time difference, gNB Rx-Tx time difference, DL PRS reference signal received power (RSRP), UL SRS RSRP, and UL AoA.

The NR based positioning solutions involve the following function entities: UE: the UE measures DL PRS resources sent from multiple different transmission/reception points (TRPs) or transmits SRS resource for positioning. TRP: For determining the location of one UE, multiple TRPs are generally involved. Each TRP can transmit DL PRS to the UE or receive and measure SRS for positioning transmitted by the UE. Location server: it can be referred to as location management function (LMF).

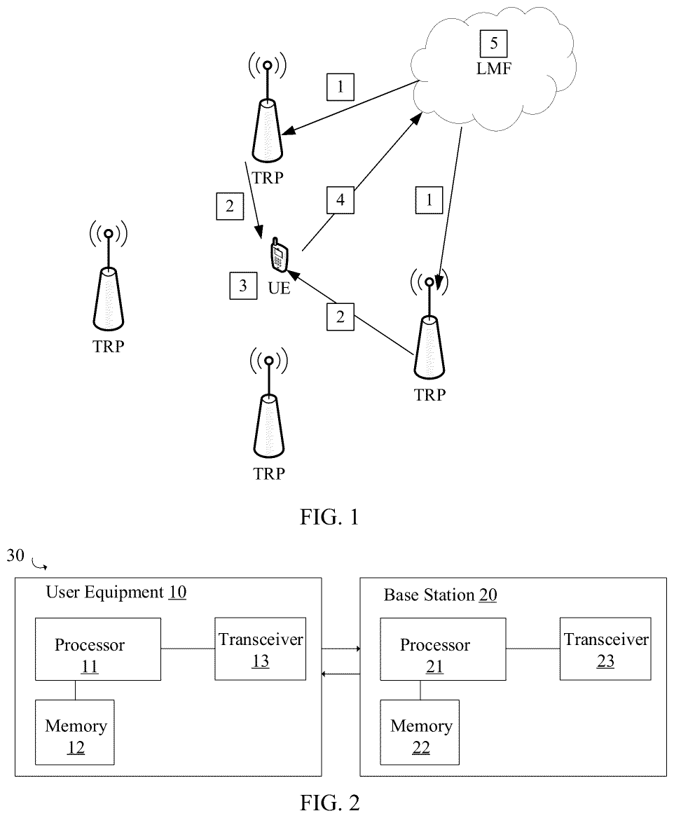

FIG. 1 illustrates an example of NR positioning based on DL measurement. As illustrated in the example, the basic procedure is as follows. The LMF and TRP coordinate DL PRS configurations. Each TRP transmits DL PRS resource according to the configuration. The UE measures DL PRS resources transmitted from multiple TRPs and then measures the DL PRS RSRP and/or DL RSTD. The UE reports the positioning measurement results to the LMF. At last, the LMF calculates the location of the UE based on the reported positioning measurement results. Specially, in DL-AoD methods, the UE measures the RSRP or path RSRP of one or more DL RS resources and then reports the measurement results to the LMF. The LMF can determine the angle of departure of one UE with respect to each TRP and then the LMF can calculate the location of the UE.

As specified in NR, the UE can be configured with one or more DL PRS resource sets, and each DL PRS resource set can consist of one or more DL PRS resources. For each DL PRS resource set, the UE is provided with the following configuration parameters:

dl-PRS-Periodicity-and-ResourceSetSlotOffset defines the DL PRS resource periodicity and takes values Tₚₑᵣ^{PRS}∈2^{μ}{4, 5, 8, 10, 16, 20, 32, 40, 64, 80, 160, 320, 640, 1280, 2560, 5120, 10240} slots, where p=0, 1, 2, 3 for dl-PRS-SubcarrierSpacing=15, 30, 60 and 120 kHz respectively and the slot offset for DL PRS resource set with respect to SFN0 slot 0. All the DL PRS resources within one DL PRS resource set are configured with the same DL PRS resource periodicity.

dl-PRS-MutingOption1 and dl-PRS-MutingOption2 define time locations where the DL PRS resource is expected to not be transmitted for a DL PRS resource set. If dl-PRS-MutingOption1 is configured, each bit in the bitmap of dl-PRS-MutingOption1 corresponds to a configurable number provided by higher layer parameter dl-prs-MutingBitRepetitionFactor of consecutive instances of a DL PRS resource set where all the DL PRS resources within the set are muted for the instance that is indicated to be muted. The length of the bitmap can be {2, 4, 6, 8, 16, 32} bits. If dl-PRS-MutingOption2 is configured each bit in the bitmap of dl-PRS-MutingOption2 corresponds to a single repetition index for each of the DL PRS resources within each instance of a nr-DL-PRS-ResourceSet and the length of the bitmap is equal to the values of dl-PRS-ResourceRepetitionFactor.

NR-DL-PRS-SFN0-Offset defines a time offset of the SFN0 slot 0 for a transmitting cell with respect to SFN0 slot 0 of a reference cell.

A bandwidth of DL PRS resource could be outside a bandwidth of one active bandwidth part (BWP), and the subcarrier spacing used by a DL PRS resource could be also different from the subcarrier spacing of an active BWP. Thus, a measurement gap is needed for a UE to measure DL PRS resource. The measurement gap for positioning is configured through radio resource control (RRC). When a UE needs to measure DL PRS resource and there is no measurement gap, the UE can request a measurement gap through an RRC signaling.

The performance of positioning and accuracy of current positioning measurement are limited by a bandwidth of PRS (positioning reference signal). In the current system, PRS can be transmitted in multiple frequency layers, but a new radio (NR) system can only support positioning measurement based on PRS in each frequency layer individually. The bandwidth of PRS in one frequency layer of positioning is limited by 100 MHz. Thus, the performance of positioning is also limited. The current NR system is unable to aggregate PRS in multiple frequency layers to formulate an equivalent larger bandwidth of PRS, which can potentially boost the accuracy of positioning measurement.

Some embodiments of the present disclosure provide solutions for phase difference measurement for positioning. FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive a configuration information of a plurality of downlink positioning reference signal (DL PRS) resources of a plurality of transmission points (TPs) from a base station, the processor 11 is configured to aggregate a first DL PRS resource and a second DL PRS resource of the DL PRS resources based on the configuration information to obtain at least one positioning measurement result, and the processor 11 is configured to report the at least one positioning measurement result to the base station. This can solve issues in the prior art and other issues, improve an accuracy of positioning measurement, and/or improve a performance of positioning service.

In some embodiments, the processor 21 is configured to configure, to a user equipment (UE), a configuration information of a plurality of downlink positioning reference signal (DL PRS) resources of a plurality of transmission points (TPs), the processor 21 is configured to request the UE to aggregate a first DL PRS resource and a second DL PRS resource of the DL PRS resources based on the configuration information to obtain at least one positioning measurement result, and the transceiver 23 is configured to receive, from the UE, the at least one positioning measurement result. This can solve issues in the prior art and other issues, improve an accuracy of positioning measurement, and/or improve a performance of positioning service.

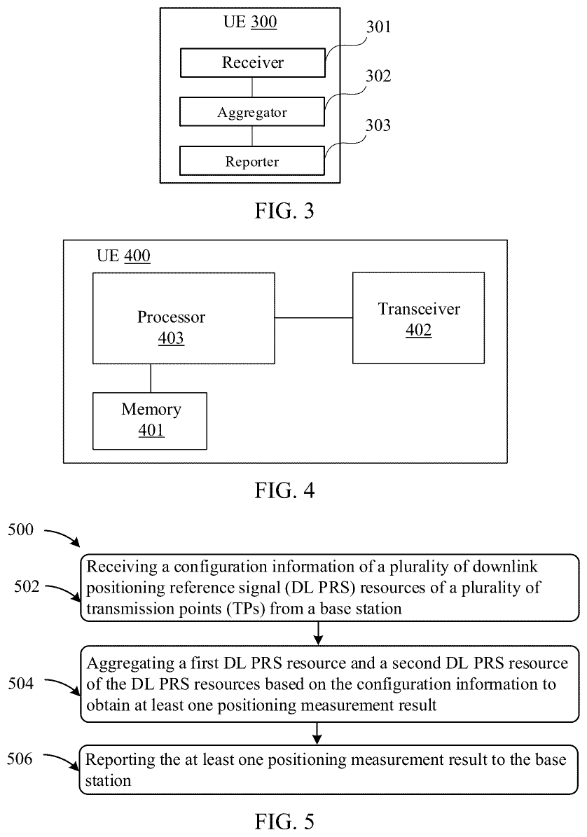

FIG. 3 illustrates an example of a UE 300 according to an embodiment of the present application. The UE 300 is configured to implement some embodiments of the disclosure. Some embodiments of the disclosure may be implemented into the UE 300 using any suitably configured hardware and/or software. The UE 300 includes a receiver 301, an aggregator 302, and a reporter 303. The receiver 301 is configured to receive a configuration information of a plurality of downlink positioning reference signal (DL PRS) resources of a plurality of transmission points (TPs) from a base station. The aggregator 302 is configured to aggregate a first DL PRS resource and a second DL PRS resource of the DL PRS resources based on the configuration information to obtain at least one positioning measurement result. The reporter 303 is configured to report the at least one positioning measurement result to the base station. This can solve issues in the prior art and other issues, improve an accuracy of positioning measurement, and/or improve a performance of positioning service.

FIG. 4 illustrates an example of a UE 400 according to an embodiment of the present disclosure. The UE 400 is configured to implement some embodiments of the disclosure. Some embodiments of the disclosure may be implemented into the UE 400 using any suitably configured hardware and/or software. The UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the transceiver 402 is configured to receive a configuration information of a plurality of downlink positioning reference signal (DL PRS) resources of a plurality of transmission points (TPs) from a base station, the processor 403 is configured to aggregate a first DL PRS resource and a second DL PRS resource of the DL PRS resources based on the configuration information to obtain at least one positioning measurement result, and the processor 403 is configured to report the at least one positioning measurement result to the base station. This can solve issues in the prior art and other issues, improve an accuracy of positioning measurement, and/or improve a performance of positioning service.

FIG. 5 is an example of a method 500 of positioning measurement performed by a UE according to an embodiment of the present disclosure. The method 500 of positioning measurement performed by a UE is configured to implement some embodiments of the disclosure. Some embodiments of the disclosure may be implemented into the method 500 of positioning measurement performed by a UE using any suitably configured hardware and/or software. In some embodiments, the method 500 of positioning measurement performed by a UE includes: an operation 502, receiving a configuration information of a plurality of downlink positioning reference signal (DL PRS) resources of a plurality of transmission points (TPs) from a base station, an operation 504, aggregating a first DL PRS resource and a second DL PRS resource of the DL PRS resources based on the configuration information to obtain at least one positioning measurement result, and an operation 506, reporting the at least one positioning measurement result to the base station. This can solve issues in the prior art and other issues, improve an accuracy of positioning measurement, and/or improve a performance of positioning service.

In some embodiments, the at least one positioning measurement result includes at least one reference signal time difference (RSTD) measurement, at least one PRS-reference signal received power (PRS-RSRP) measurement, and/or at least one UE receive-transmit (Rx-Tx) time difference measurement. In some embodiments, the first DL PRS resource and the second DL PRS resource are configured in different frequency layers for positioning. In some embodiments, for each positioning measurement, the UE reports if the at least one positioning measurement result is obtained by aggregating the first DL PRS resource and the second DL PRS resource. In some embodiments, for each positioning measurement, the UE reports identifiers (IDs) of the first DL PRS resource and the second DL PRS resource. In some embodiments, the configuration information includes a request for positioning measurement based on the DL PRS resources. In some embodiments, the configuration information includes a first indicator configured to indicate whether to aggregate the first DL PRS resource and the second DL PRS resource. In some embodiments, the first DL PRS resource and the second DL PRS resource with the first indicator are set to a same value.

In some embodiments, the configuration information includes at least one list of DL PRS resource IDs configured to indicate whether to aggregate the first DL PRS resource and the second DL PRS resource. In some embodiments, DL PRS resource IDs of the first DL PRS resource and the second DL PRS resource are configured in a same list. In some embodiments, the configuration information includes at least one DL PRS positioning frequency layer configuration, where a DL PRS positioning frequency layer is defined as a collection of DL PRS resource sets having common parameters. In some embodiments, the UE determines if two DL PRS resources on two different PRS positioning frequency layers are aggregated for positioning measurement based on the configuration information.

In some embodiments, the at least one RSTD measurement includes at least one of the following: an indicator used to indicate whether a corresponding DL RSTD measurement is obtained by aggregating DL PRS resources, an ID of a DL PRS resource that the UE aggregates to obtain the corresponding DL RSTD measurement, a RSRP measurement of corresponding aggregated DL PRS resources used to obtain the DL RSTD measurement, a path RSRP of aggregated DL PRS resources, and a relative arrival time of the aggregated DL PRS resources.

In some embodiments, the at least one PRS-RSRP measurement includes at least one of the following: an indicator used to indicate whether the at least one PRS-RSRP measurement is obtained by aggregating DL PRS resources, an ID of a DL PRS resource that the UE aggregates to obtain the at least one PRS-RSRP measurement, and a path RSRP of aggregated DL PRS resources.

In some embodiments, the at least one UE Rx-Tx time difference measurement includes at least one of the following: an indicator used to indicate whether the at least one UE Rx-Tx time difference measurement is obtained by aggregating DL PRS resources, an ID of a DL PRS resource that the UE aggregates to obtain the at least one UE Rx-Tx time difference measurement, a RSRP measurement of corresponding aggregated DL PRS resources that are used to obtain the at least one UE Rx-Tx time difference measurement, a path RSRP of aggregated DL PRS resources, and a relative arrival time of the aggregated DL PRS resources.

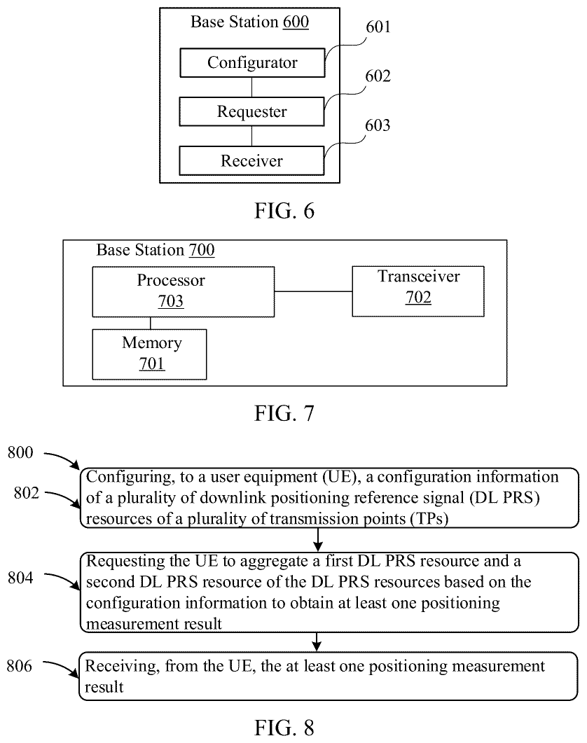

FIG. 6 illustrates an example of base station 600 according to an embodiment of the present application. The base station 600 is configured to implement some embodiments of the disclosure. Some embodiments of the disclosure may be implemented into the base station 600 using any suitably configured hardware and/or software. The base station 600 includes a configurator 601, a requester 602, and a receiver 603. The configurator 601 is configured to configure, to a user equipment (UE), a configuration information of a plurality of downlink positioning reference signal (DL PRS) resources of a plurality of transmission points (TPs). The requester 602 is configured to request the UE to aggregate a first DL PRS resource and a second DL PRS resource of the DL PRS resources based on the configuration information to obtain at least one positioning measurement result. The receiver 603 is configured to receive, from the UE, the at least one positioning measurement result. This can solve issues in the prior art and other issues, improve an accuracy of positioning measurement, and/or improve a performance of positioning service.

FIG. 7 illustrates an example of abase station 700 according to an embodiment of the present disclosure. The base station 700 is configured to implement some embodiments of the disclosure. Some embodiments of the disclosure may be implemented into the base station 700 using any suitably configured hardware and/or software. The base station 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the processor 703 is configured to configure, to a user equipment (UE), a configuration information of a plurality of downlink positioning reference signal (DL PRS) resources of a plurality of transmission points (TPs), the processor 703 is configured to request the UE to aggregate a first DL PRS resource and a second DL PRS resource of the DL PRS resources based on the configuration information to obtain at least one positioning measurement result, and the transceiver 702 is configured to receive, from the UE, the at least one positioning measurement result. This can solve issues in the prior art and other issues, improve an accuracy of positioning measurement, and/or improve a performance of positioning service.

FIG. 8 is an example of a method 800 of positioning measurement performed by a base station according to an embodiment of the present disclosure. The method 800 of positioning measurement performed by the base station is configured to implement some embodiments of the disclosure. Some embodiments of the disclosure may be implemented into the method 800 of positioning measurement performed by the base station using any suitably configured hardware and/or software. In some embodiments, the method 800 of positioning measurement performed by the base station includes: an operation 802, configuring, to a user equipment (UE), a configuration information of a plurality of downlink positioning reference signal (DL PRS) resources of a plurality of transmission points (TPs), an operation 804, requesting the UE to aggregate a first DL PRS resource and a second DL PRS resource of the DL PRS resources based on the configuration information to obtain at least one positioning measurement result, and an operation 806, receiving, from the UE, the at least one positioning measurement result. This can solve issues in the prior art and other issues, improve an accuracy of positioning measurement, and/or improve a performance of positioning service.

In some embodiments, the at least one positioning measurement result includes at least one reference signal time difference (RSTD) measurement, at least one PRS-reference signal received power (PRS-RSRP) measurement, and/or at least one UE receive-transmit (Rx-Tx) time difference measurement. In some embodiments, the first DL PRS resource and the second DL PRS resource are configured in different frequency layers for positioning. In some embodiments, for each positioning measurement, the at least one positioning measurement result includes if the at least one positioning measurement result is obtained by aggregating the first DL PRS resource and the second DL PRS resource. In some embodiments, for each positioning measurement, the at least one positioning measurement result includes identifiers (IDs) of the first DL PRS resource and the second DL PRS resource. In some embodiments, the configuration information includes a request for positioning measurement based on the DL PRS resources.

In some embodiments, the configuration information includes a first indicator configured to indicate whether to aggregate the first DL PRS resource and the second DL PRS resource. In some embodiments, the first DL PRS resource and the second DL PRS resource with the first indicator are set to a same value. In some embodiments, the configuration information includes at least one list of DL PRS resource IDs configured to indicate whether to aggregate the first DL PRS resource and the second DL PRS resource. In some embodiments, DL PRS resource IDs of the first DL PRS resource and the second DL PRS resource are configured in a same list. In some embodiments, the configuration information includes at least one DL PRS positioning frequency layer configuration, where a DL PRS positioning frequency layer is defined as a collection of DL PRS resource sets having common parameters. In some embodiments, the at least one positioning measurement result includes if two DL PRS resources on two different PRS positioning frequency layers are aggregated for positioning measurement based on the configuration information.

In some embodiments, the at least one RSTD measurement includes at least one of the following: an indicator used to indicate whether a corresponding DL RSTD measurement is obtained by aggregating DL PRS resources, an ID of an aggregated DL PRS resource used to obtain the corresponding DL RSTD measurement, a RSRP measurement of corresponding aggregated DL PRS resources used to obtain the DL RSTD measurement; a path RSRP of aggregated DL PRS resources, and a relative arrival time of the aggregated DL PRS resources.

In some embodiments, the at least one PRS-RSRP measurement includes at least one of the following: an indicator used to indicate whether the at least one PRS-RSRP measurement is obtained by aggregating DL PRS resources, an ID of an aggregated DL PRS resource used to obtain the at least one PRS-RSRP measurement, and a path RSRP of aggregated DL PRS resources.

In some embodiments, the at least one UE Rx-Tx time difference measurement includes at least one of the following: an indicator used to indicate whether the at least one UE Rx-Tx time difference measurement is obtained by aggregating DL PRS resources, an ID of an aggregated DL PRS resource used to obtain the at least one UE Rx-Tx time difference measurement, a RSRP measurement of corresponding aggregated DL PRS resources that are used to obtain the at least one UE Rx-Tx time difference measurement, a path RSRP of aggregated DL PRS resources, and a relative arrival time of the aggregated DL PRS resources.

### Exemplary Technical Solutions:

In some embodiments, a system can provide a configuration information of DL PRS resources of multiple transmission points (TPs) to a UE. The system transmits the DL PRS resource to the UE, and the UE can be requested to measure the DL PRS resource to obtain positioning measurement results, for example, a RSTD measurement, a PRS-RSRP measurement, and a UE Rx-Tx time difference measurement. In some embodiments, the system can indicate the UE that a first DL PRS resource and a second DL PRS resource can be aggregated together for positioning measurement, where those two PRS resources can be configured in different frequency layers for positioning.

In some embodiments, the system can indicate the UE that a first DL PRS resource, a second DL PRS resource, and a third DL PRS resource can be aggregated together for positioning measurement. The system can request UE to measure some particular positioning measurement results, for example a RSTD measurement, a PRS-RSRP, and a UE Rx-Tx time difference based on aggregating multiple DL PRS resources. With the corresponding configuration and indication, the UE can receive the first DL PRS resource, the second DL PRS resource, and the third DL PRS resource. The UE then can aggregate them together to obtain the corresponding positioning measurement. The UE can report the positioning measurement result to the system. For each positioning measurement, the UE can report if the measurement result is obtained by aggregating DL PRS resources. For each measurement result, the UE can also report the IDs of those DL PRS resources that the UE aggregate for obtaining the measurement result.

In one illustrative method, the UE can be configured with one or more DL PRS resource set configurations through a high layer signaling by the system. Each DL PRS resource set consists of one or more DL PRS resources. In the configuration of DL PRS resources, the system can provide indication information that indicate which ones of the DL PRS resource the UE can aggregate for positioning measurement. For example, the system can provide indication information for a first DL PRS resource and a second DL PRS resource, and the indication information indicates the UE that the UE can aggregate the first DL PRS resource and the second DL PRS resource to obtain positioning measurement, for example a RSTD measurement, a UE Rx-Tx time difference measurement, and/or a RSRP measurement of PRS.

In a first example, the system can provide a first indicator in the configuration of one DL PRS resource and the indicator can be set to some values, for example 0, 1, 2, 3, . . . . The first indicator in one DL PRS resource is used to indicate whether this DL PRS resource can be aggregated with another DL PRS resource. The DL PRS resources with the first indicator being set to same value can be aggregated for positioning measurement. In other words, the UE can aggregate two DL PRS resources with the first indicator being set to the same value to obtain the positioning measurement.

In a second example, the system can provide one or more lists of DL PRS resource IDs to indicate whether two DL PRS resources can be aggregated for positioning measurement. The DL PRS resources of the DL PRS resource IDs configured in the same list can be aggregated for positioning measurement. For example, the system provides a list of DL PRS resource IDs for aggregation for positioning measurement: {a first DL PRS resource ID, a second DL PRS resource ID}. Then the UE can aggregate the DL PRS resource with the first DL PRS resource ID and the DL PRS resource with the second DL PRS resource ID for positioning measurement.

In a third example, for the configuration of DL PRS resources, the UE can be configured with one or more DL PRS positioning frequency layer configurations, where a DL PRS positioning frequency layer is defined as a collection of DL PRS resource sets which have common parameters. One DL PRS positioning frequency layer configuration includes the following parameters which are common for all the DL PRS resource sets in this positioning frequency layer: PRS subcarrier spacing, cyclic prefix, and/or PRS pointA. In one DL PRS positioning frequency layer configuration, the UE can be provided one or more DL PRS resource sets, and each DL PRS resource set can include one or more DL PRS resources.

To support the indication of DL PRS resource aggregation, in some examples, the system can provide one indicator in one DL PRS positioning frequency layer configuration and the value of the indicator can indicate whether the DL PRS resources in two DL PRS positioning frequency layer configurations can be aggregated for positioning measurement. For example, the system provides one indicator in a first DL PRS positioning frequency layer and one indicator in a second DL PRS positioning frequency layer. If the indicators in these two DL PRS positioning frequency layer configurations are set to the same value, the UE can aggregate one DL PRS resource in the first DL PRS positioning frequency layer and the corresponding DL PRS resource in the second DL PRS positioning frequency layer for positioning measurement.

In some examples, the system can provide one indicator in one DL PRS resource set, and the value of the indicator can indicate whether the DL PRS resources in two DL PRS resource sets can be aggregated for positioning measurement. For example, the system provides one indicator in a first DL PRS resource set and one indicator in a second DL PRS resource set. If the indicators in these two DL PRS resource sets are set to the same value, the UE can aggregate one DL PRS resource in the first DL PRS resource set and the corresponding DL PRS resource in the second DL PRS resource set for positioning measurement.

In a fourth example, for the configuration of DL PRS resources, the UE can be configured with one or more DL PRS positioning frequency layer configurations, where a DL PRS positioning frequency layer is defined as a collection of DL PRS resource sets which have common parameters. One DL PRS positioning frequency layer configuration includes the following parameters which are common for all the DL PRS resource sets in this positioning frequency layer: PRS subcarrier spacing, cyclic prefix, and/or PRS pointA. In one DL PRS positioning frequency layer configuration, the UE can be provided one or more DL PRS resource sets and each DL PRS resource set can include one or more DL PRS resources. To support the indication of DL PRS resource aggregation, the system can provide one associated DL PRS positioning frequency layer configuration in a first DL PRS positioning frequency layer configuration. With such configuration, all the DL PRS resource sets configured in the first DL PRS positioning frequency layer configuration would also apply to the associated DL PRS positioning frequency layer. The UE can aggregate one DL PRS resource in the first DL PRS positioning frequency layer and the corresponding DL PRS resource in the associated DL PRS positioning frequency layer for positioning measurement.

For example, the following message can be used to support this new function:

```
  NR-DL-PRS-AssistanceDataPerFreq-r16 ::= SEQUENCE {
      nr-DL-PRS-PositioningFrequencyLayer-r16 NR-DL-PRS-PositioningFrequencyLayer-r16,
      nr-DL-PRS-AssistanceDataPerFreq-r16 SEQUENCE (SIZE (1..nrMaxTRPsPerFreq-r16)) OF
NR-DL-PRS-AssistanceDataPerTRP-r16
  Alt#1:
    associated_nr-DL-PRS-PositioningFrequencyLayer NR-DL-PRS-PositioningFrequencyLayer-r16
    2ndAssociated_nr-DL-PRS-PositioningFrequencyLayer NR-DL-PRS-
PositioningFrequencyLayer-r16
  Alt#2:
  associated_nr-DL-PRS-PositioningFrequencyLayer SEQUENCE(SIZE(1..nrMaxAssociatedPFL)) OF
NR-DL-PRS-PositioningFrequencyLayer-r16
  }
  NR-DL-PRS-PositioningFrequencyLayer-r16 ::= SEQUENCE {
    dl-PRS-SubcarrierSpacing-r16 ENUMERATED {kHz15, kHz30, kHz60, kHz120, ...},
    dl-PRS-ResourceBandwidth-r16 INTEGER (1..63),
    dl-PRS-StartPRB-r16 INTEGER (0..2176),
    dl-PRS-PointA-r16 ARFCN-ValueNR-r15,
    dl-PRS-CombSizeN-r16 ENUMERATED {n2, n4, n6, n12, ...},
    dl-PRS-CyclicPrefix-r16 ENUMERATED {normal, extended, ...},
  ...
}
```

The IE associated_nr-DL-PRS-PositioningFrequencyLayer can configure one associated DL PRS positioning frequency layer for DL PRS resource aggregation. In some cases, the system might request the UE to aggregate DL PRS resources in more than two positioning frequency layers for positioning measurement. Thus, the system can provide more than one associated DL PRS positioning frequency layer configurations in the first DL PRS positioning frequency layer configuration. In the above example for message design, the IE 2ndAssociated_nr-DL-PRS-PositioningFrequencyLayer can configure the second associated DL PRS positioning frequency layer for DL PRS resource aggregation. In another example, the IE associated_nr-DL-PRS-PositioningFrequencyLayer can provide a list of associated DL PRS positioning frequency layers.

In a fifth example, a UE can determine if two DL PRS resources on two different PRS positioning frequency layers can be aggregated for positioning measurement based on the configuration of DL PRS resources. For example, a first DL PRS positioning frequency layer and a second DL PRS positioning frequency layer are configured with the same subcarrier spacing and cyclic prefix. If a first DL PRS resource in the first DL PRS positioning frequency layer and a second DL PRS resource in the second DL PRS positioning frequency layer are transmitted in the same slot and on the same OFDM symbol(s), the UE can aggregate the first DL PRS resource and the second DL PRS resource for positioning measurement.

In one illustrative method, the system can request one UE to obtain positioning measurement results and report the positioning measurement results to the system. For example, the system can request the UE to report positioning measurement results for DL-TDOA positioning. For example, the system can request the UE to report positioning measurement results for DL-AoD positioning. For example, the system can request the UE to report UE Rx-Tx time difference measurement results. For one positioning measurement, the system can request the UE to obtain the positioning measurement result by aggregating multiple DL PRS resources on different DL PRS positioning frequency layers. In each positioning measurement reporting, the UE can report that one positioning measurement result is obtained by aggregating DL PRS resources in different DL PRS positioning frequency layers. For each positioning measurement reporting that is obtained from aggregating multiple DL PRS resources, the UE can also report the IDs of the DL PRS resources that are aggregated to obtain the corresponding positioning measurement.

In a first example, for DL-TDOA positioning, the system can request the UE to report DL RSTD measurement results to the system. According to the configuration of DL PRS resources, the UE can obtain the DL RSTD measurement by aggregating DL PRS resources. Then the UE can report one or more DL RSTD measurement to the system. For each reported DL RSTD measurement result, the UE can report the following.

An indicator to indicate whether the corresponding DL RSTD measurement is obtained by aggregating DL PRS resources.

The ID(s) of DL PRS resource that the UE aggregates to obtain the corresponding DL RSTD measurement result.

The RSRP measurement of the corresponding aggregated DL PRS resources that are used to obtain the DL RSTD measurement.

The UE can also report the path RSRP of the aggregated DL PRS resources.

The UE can also report the relative arrival time of the aggregated DL PRS resources.

In a second example, for multi-RTT positioning, the system can request the UE to report UE Rx-Tx time difference measurement results to the system. According to the configuration of DL PRS resources, the UE can obtain the UE Rx-Tx time difference measurement by aggregating DL PRS resources. Then the UE can report one or more UE Rx-Tx time difference measurement to the system. For each reported UE Rx-Tx time difference measurement result, the UE can report the following.

An indicator to indicate whether the corresponding UE Rx-Tx time difference measurement is obtained by aggregating DL PRS resources.

The ID(s) of DL PRS resource that the UE aggregate to obtain the corresponding UE Rx-Tx time difference measurement result.

The RSRP measurement of the corresponding aggregated DL PRS resources that are used to obtain the UE Rx-Tx time difference measurement.

The UE can also report the path RSRP of the aggregated DL PRS resources.

The UE can also report the relative arrival time of the aggregated DL PRS resources.

In a third example, DL-AoD positioning, the system can request the UE to report PRS RSRP measurement results to the system. According to the configuration of DL PRS resources, the UE can obtain the PRS RSRP measurement by aggregating DL PRS resources. Then the UE can report one or more PRS RSRP measurement to the system. For each reported UE PRS RSRP measurement result, the UE can report the following.

An indicator to indicate whether the corresponding PRS RSRP measurement is obtained by aggregating DL PRS resources.

The ID(s) of DL PRS resource that the UE aggregate to obtain the corresponding PRS RSRP measurement result.

The UE can also report the path RSRP of the aggregated DL PRS resources.

With the proposed methods, the NR system can support aggregating multiple DL PRS resources on different frequency layers to formulate an equivalent PRS with much larger bandwidth for positioning measurement. The larger bandwidth of PRS can improve the accuracy of positioning measurement and thus improve the performance of positioning service.

Commercial interests for some embodiments are as follows. 1. Solve issues in the prior art and other issues. 2. Improve an accuracy of positioning measurement. 3. Improve a performance of positioning service. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of positioning measurement are considered for standardizing.

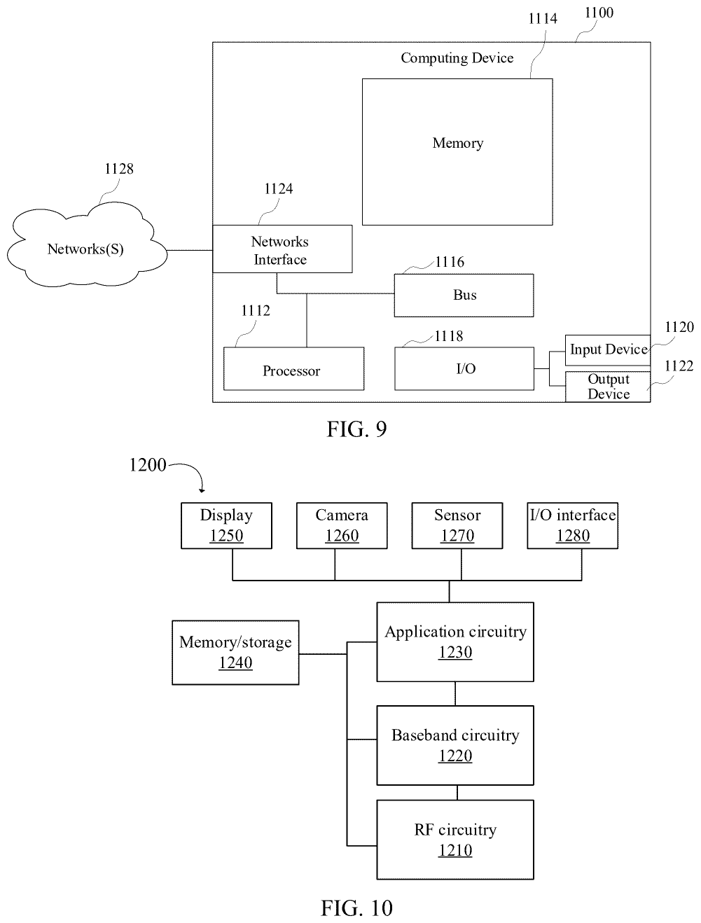

FIG. 9 is an example of a computing device 1100 according to an embodiment of the present disclosure. Any suitable computing device can be used for performing the operations described herein. For example, FIG. 9 illustrates an example of the computing device 1100 that can implement some embodiments of FIG. 2 to FIG. 8 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 2 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 10 is a block diagram of an example of a communication system 1200 according to an embodiment of the present disclosure. Embodiments described herein may be implemented into the communication system 1200 using any suitably configured hardware and/or software. FIG. 10 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 2 to FIG. 8. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 2 to FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method of positioning measurement, by a user equipment (UE), comprising:
receiving a configuration information of a plurality of downlink positioning reference signal (DL PRS) resources of a plurality of transmission points (TPs) from a base station;
aggregating a first DL PRS resource and a second DL PRS resource of the DL PRS resources based on the configuration information to obtain at least one positioning measurement result; and
reporting the at least one positioning measurement result to the base station.

2. The method of claim 1, wherein the at least one positioning measurement result comprises at least one reference signal time difference (RSTD) measurement, at least one PRS-reference signal received power (PRS-RSRP) measurement, and/or at least one UE receive-transmit (Rx-Tx) time difference measurement.

3. The method of claim 1, wherein the first DL PRS resource and the second DL PRS resource are configured in different frequency layers for positioning.

4. The method of claim 1, wherein for each positioning measurement, the UE reports if the at least one positioning measurement result is obtained by aggregating the first DL PRS resource and the second DL PRS resource.

5. The method of claim 1, wherein for each positioning measurement, the UE reports identifiers (IDs) of the first DL PRS resource and the second DL PRS resource.

6. The method of claim 1, wherein the configuration information comprises a request for positioning measurement based on the DL PRS resources.

7. The method of claim 1, wherein the configuration information comprises a first indicator configured to indicate whether to aggregate the first DL PRS resource and the second DL PRS resource.

8. The method of claim 7, wherein the first DL PRS resource and the second DL PRS resource with the first indicator are set to a same value.

9. The method of claim 1, wherein the configuration information comprises at least one list of DL PRS resource IDs configured to indicate whether to aggregate the first DL PRS resource and the second DL PRS resource, wherein DL PRS resource IDs of the first DL PRS resource and the second DL PRS resource are configured in a same list.

10. The method of claim 1, wherein the configuration information comprises at least one DL PRS positioning frequency layer configuration, where a DL PRS positioning frequency layer is defined as a collection of DL PRS resource sets having common parameters.

11. The method of claim 1, wherein the UE determines if two DL PRS resources on two different PRS positioning frequency layers are aggregated for positioning measurement based on the configuration information.

12. The method of claim 2, wherein the at least one RSTD measurement comprises at least one of the following:
an indicator used to indicate whether a corresponding DL RSTD measurement is obtained by aggregating DL PRS resources;
an ID of a DL PRS resource that the UE aggregates to obtain the corresponding DL RSTD measurement;
a RSRP measurement of corresponding aggregated DL PRS resources used to obtain the DL RSTD measurement;
a path RSRP of aggregated DL PRS resources; and
a relative arrival time of the aggregated DL PRS resources;
and/or
wherein the at least one PRS-RSRP measurement comprises at least one of the following:
an indicator used to indicate whether the at least one PRS-RSRP measurement is obtained by aggregating DL PRS resources;
an ID of a DL PRS resource that the UE aggregates to obtain the at least one PRS-RSRP measurement; and
a path RSRP of aggregated DL PRS resources;
and/or
wherein the at least one UE Rx-Tx time difference measurement comprises at least one of the following:
an indicator used to indicate whether the at least one UE Rx-Tx time difference measurement is obtained by aggregating DL PRS resources;
an ID of a DL PRS resource that the UE aggregates to obtain the at least one UE Rx-Tx time difference measurement;
a RSRP measurement of corresponding aggregated DL PRS resources that are used to obtain the at least one UE Rx-Tx time difference measurement;
a path RSRP of aggregated DL PRS resources; and
a relative arrival time of the aggregated DL PRS resources.

13. A wireless communication method of positioning measurement, by a base station, comprising:
configuring, to a user equipment (UE), a configuration information of a plurality of downlink positioning reference signal (DL PRS) resources of a plurality of transmission points (TPs);
requesting the UE to aggregate a first DL PRS resource and a second DL PRS resource of the DL PRS resources based on the configuration information to obtain at least one positioning measurement result; and
receiving, from the UE, the at least one positioning measurement result.

14. The method of claim 13, wherein the at least one positioning measurement result comprises at least one reference signal time difference (RSTD) measurement, at least one PRS-reference signal received power (PRS-RSRP) measurement, and/or at least one UE receive-transmit (Rx-Tx) time difference measurement.

15. The method of claim 13, wherein the first DL PRS resource and the second DL PRS resource are configured in different frequency layers for positioning.

16. The method of claim 13, wherein for each positioning measurement, the at least one positioning measurement result comprises if the at least one positioning measurement result is obtained by aggregating the first DL PRS resource and the second DL PRS resource.

17. A user equipment (UE), comprising:
a memory;
a transceiver; and
a processor coupled to the memory and the transceiver;
wherein the UE is configured to:
receive a configuration information of a plurality of downlink positioning reference signal (DL PRS) resources of a plurality of transmission points (TPs) from a base station;
aggregate a first DL PRS resource and a second DL PRS resource of the DL PRS resources based on the configuration information to obtain at least one positioning measurement result; and
report the at least one positioning measurement result to the base station.

18. The UE of claim 17, wherein the at least one positioning measurement result comprises at least one reference signal time difference (RSTD) measurement, at least one PRS-reference signal received power (PRS-RSRP) measurement, and/or at least one UE receive-transmit (Rx-Tx) time difference measurement.

19. The UE of claim 17, wherein the first DL PRS resource and the second DL PRS resource are configured in different frequency layers for positioning.

20. The UE of claim 17, wherein for each positioning measurement, the UE reports if the at least one positioning measurement result is obtained by aggregating the first DL PRS resource and the second DL PRS resource.
